(19) United States
(12) Patent Application Publication
(10) Pub. No.: US 2016/0336888 A1
(43) Pub. Date: Nov. 17, 2016

(54) METHOD AND REGULATION AND/OR CONTROL DEVICE FOR OPERATING A WIND TURBINE AND/OR A WIND PARK, AND WIND TURBINE AND WIND PARK

(71) Applicant: WOBBEN PROPERTIES GMBH, Aurich (DE)

(72) Inventor: Kai Busker, Großefehn (DE)

(21) Appl. No.: 15/112,128

(22) PCT Filed: Jan. 7, 2015
(86) PCT No.: PCT/EP2015/050143

§ 371 Date: Jul. 15, 2016

(30) Foreign Application Priority Data
Jan. 16, 2014 (DE) 10 2014 200 740.2

(51) Int. Cl. H02P 9/10; F03D 9/00; H02J 3/24

(52) U.S. Cl. CPC H02P 9/105; H02J 3/24; F03D 9/005

(57) ABSTRACT

A method for operating a wind turbine and/or a wind farm for feeding electric power into an electrical supply grid, wherein an output power, in particular an active and/or reactive power, is regulated by means of at least one power regulation module of a regulation and/or control device, wherein provision is made for a power regulation input value to be preset and a power regulation output value to be determined from the power regulation input value and for a power regulation output value to be output, and provision is additionally made for a time profile of the output power of the wind energy generation to be detected over a detection time period and for a time profile of the line voltage of the electrical supply grid to be detected over a detection time period, wherein a check is performed over the detection time period to ascertain whether the output power and the line voltage have an oscillation profile. In accordance with the disclosure, provision is made for an oscillation with a period and with an amplitude to be assigned to the oscillation profile and for it to be established that the oscillation continues over the detection time period and does not decrease in the process, and for a signal to be output for signalling an oscillation buildup state.

### BACKGROUND

1. Technical Field

The present invention relates to a method for operating a wind turbine and/or a wind farm and to a regulation and/or control device for operating a wind turbine and/or a wind farm. Furthermore, the present invention relates to a wind turbine and to a wind farm.

2. Description of the Related Art

Generally, a wind turbine and/or a wind farm can be defined as a wind energy generator, i.e., an energy generation plant, for generating energy from wind energy, which is in particular designed for feeding electric power into an electrical supply grid.

Feeding of electrical energy into an electrical supply grid, such as, for example, the European interconnected grid or the US electrical grid, is generally known. In this case, an electrical supply grid will be understood below to mean an AC voltage grid, as has become generally prevalent. This does not rule out the possibility of there being DC voltage sections in the grid. Likewise, aspects which are frequency-independent can in any case also relate in principle to a DC voltage grid. Historically, a feed into an electrical supply grid takes place using a large-scale power plant which drives a synchronous generator from primary energy, such as, for example, coal, nuclear energy or gas. Depending on the pole pair number of the synchronous generator and the speed of the synchronous generator, said synchronous generator feeds into the supply grid at a specific frequency. The synchronous generator can be influenced by control engineering in order to set the power, for example. Such an adjustment process can be slow, however. In the case of varying situations in the supply grid into which there is to be a feed, the physical response of the synchronous generator often, in any case for a short period of time, influences a change in a grid state. For example, the speed of the synchronous generator is increased when the supply grid cannot draw the full power which is or can be provided by the synchronous generator. The therefore excess power then accelerates the synchronous generator, which becomes noticeable in an increase in the feed-in frequency. Correspondingly, the frequency on a supply grid can be increased.

It is generally known to generate electric power by means of wind turbines and to feed this electric power into an electrical supply grid. For feeding-in electrical energy by means of decentralized generation units, such as in particular wind turbines, the problem of the loss of stability in the grid, a term which is also used in the German language in the technical field and which is abbreviated by “LOS”, is in principle unknown. Although proposals have been made for the first time since the middle of the year 2000 in respect of allowing wind turbines to contribute to an electrical backup for the grid, this does not take into consideration the cause of a loss of stability, in particular it does not take into consideration the possibility of the cause of the loss of stability being the feed into the supply grid.

The loss of grid stability, i.e., the loss of stability on the supply grid, can result in shutdown of the feeding energy generation unit. Such a loss of stability (LOS) describes processes of a physical nature which no longer permit continued operation and need to be ended by shutdowns. The loss of grid stability (LOS) should be understood to mean a phenomenon in which first angular stability is lost, which can ultimately result in the loss of voltage stability. In the case of power plants, the power of said power plants then fails and, as a result, can contribute to an escalation of so-called power deficit.

In particular overcurrents to be achieved which need to be capable of being provided in the event of the occurrence of a loss of stability are established as stability criteria. This presupposes a corresponding configuration of the systems. A new power plant or similar energy generation unit, in particular a power plant to be newly built, is therefore matched to the supply grid, as is demonstrated at the point of connection to which the power plant is intended to be connected. It may prove to be problematic to adhere to this basic matching stipulation even during the construction of a wind farm or similar wind energy generation unit which to this extent is only partially in operation.

US 2007/0085343 A1 discloses by way of example a method for controlling a wind turbine depending on a change in a system parameter for the operation of an electrical supply grid. In this case, the wind turbine is operated at a higher output power for output into the electrical supply system, in comparison with a rated operation. With respect to FIG. 3 in US 2007/0085343 A1, the possibility is described of compensating for oscillations in a system frequency of the electrical supply grid as a consequence of a load failure.

WO 2011/000754 A1 discloses a method for detecting electrical variables of a three-phase AC voltage grid comprising a first, second and third phase comprising the following steps: measuring in each case one voltage value, transforming the voltage values and repeating the measurement and transformation. This is conducive to a detection of primarily the electrical voltages of the electrical supply grid in a manner which is as accurate and timely as possible.

The German Patent and Trademark Office has searched the following prior art in the priority application: WO 2013/102791 A1, WO 2011/000754 A1, U.S. Pat. No. 7,639,893 B2, US 2007/0085343 A1 and DE 10 2011 086 988 B3.

A wind turbine, i.e., a single wind energy generation unit which is connected to the electrical supply grid for feeding in electrical energy via a point of connection provided for said wind turbine (said point of connection sometimes also being referred to as connection point or feed-in point), is shown schematically in FIG. 1.

Increasingly, instead of operating individual installations, a plurality of wind turbines are also erected in a wind farm, which can feed a correspondingly large amount of power into the supply grid. In principle, a wind farm is understood to mean a number of wind turbines, but at least two wind turbines, which are connected to the electrical supply grid for feeding in electrical energy via a single point of connection. Such a wind farm is shown schematically in FIG. 2 and is characterized in particular by a point of common connection, via which all of the wind turbines in the wind farm feed into the electrical supply grid. Although the wind farm, in that case referred to as a mixed farm, can also comprise individual wind turbines each having a separate point of connection, a mixed farm can also comprise a number of wind farms and a number of individual wind turbines.

In comparison with individual wind turbines, wind farms can not only feed a comparatively high power into the electrical supply grid, but they have in principle a correspondingly significant regulation potential for stabilizing the electrical supply grid. To this extent, for example, the U.S. Pat. No. 7,638,893 proposes that, for example, the operator of the electrical supply grid can provide the wind farm with a power preset in order to reduce the farm power to be fed in order thus to have a further control possibility for its supply grid. Such regulation interventions can in this case be weak, depending on the size of the wind farm. In addition, they can be difficult to handle owing to the fact that wind turbines and also wind farms are decentralized generation units because they are distributed over a comparatively large area over a region in which the respective electrical supply grid is operated.

Furthermore, in some countries, such as Germany, for example, attempts are being made to replace conventional large-scale power plants, in particular nuclear power plants, with regenerative energy generators, such as wind turbines. In this case, however, there is the problem that the grid-stabilizing effect of a large-scale power plant is also lost when such a large-scale power plant is shutdown and “taken from the grid”. The remaining energy generation units or energy generation units which are newly being added are thus required to at least take into consideration this change in stability. A problematic factor consists in that, even in the case of an individual wind turbine feeding into the grid or in the case of a wind farm feeding into the grid, the response time for the build-up of a grid-stabilizing effect may be too slow. In principle, this is a requirement since a wind turbine or a wind farm is a wind energy generator which is dependent on the present supply of wind, i.e., is a power generator. If, furthermore, there is only a limited possibility of responding quickly to present wind conditions, this makes the performance of grid-stabilizing effects more difficult or prevents this.

First it is necessary to distinguish problematic situations of the wind turbine itself or of the wind farm as such from the abovementioned problems of grid stabilization. This applies not only to problematic wind situations but above all also during a construction phase of a wind farm. It becomes apparent that, as in principle in the case of any control and regulation system having a controlled system, a control and regulation apparatus for a wind turbine can, in the case of overcontrolled operating conditions, have the tendency to cause the wind turbine to output an unsuitable power, in particular an oscillating power output. This can have different causes, but generally can be attributed to a situation in which unsynchronized or disadvantageously synchronized matching between the control device and the regulation device for the wind turbine or wind farm as such can be assumed. It may be problematic, overall, to operate a wind turbine, firstly, so as to avoid undesired control-related and regulation-related states of emergency but secondly to configure a control facility and regulation facility of the wind turbine for a grid-stabilizing effect, which may possibly be outside the rated operating mode. To this extent, the problem area of a grid-stabilizing operating mode of a wind turbine, on the one hand, and of avoiding disadvantageous states (because in particular they are susceptible to oscillation) of a control and/or regulation device, on the other hand, is to distinguish between cause and effect, but these can also mutually influence one another.

It is desirable to enable a power output of a wind energy generation unit, in particular a wind turbine and/or a wind farm, which is as reliable as possible, even in regions which are in principle less advantageous, in particular in respect of the regulation situation, for example outside of rated operation or in the case of a wind farm which is only partially complete but is already partially being used. Even against this background, a grid-stabilizing approach with an output power into the electrical supply grid is desirable.

A solution by means of which a wind energy generation unit, in particular a wind turbine and/or a wind farm, can improve backup for an electrical supply grid is desirable; this can be used in order to provide a supply grid which is as stable as possible and/or to operate the wind energy generation unit within intentional and desired regulation and control states, in particular even when a regulation and control device and the wind energy generation unit are not yet optimized or matched to one another.

### BRIEF SUMMARY

An apparatus and a method by means of which an output power of a wind turbine and/or a wind farm can be at least monitored, in particular regulated and/or controlled, in an improved manner is provided. In particular, the invention involves developing an apparatus and a method in such a way that the output power can firstly be regulated comparatively accurately in a reliable manner. In particular an improved response time to acute wind conditions and/or operating conditions of the wind turbine and/or a wind farm should be provided thereby; this is in particular in order to achieve a grid-stabilizing effect furthermore in an improved manner, in particular in any case not to restrict this grid-stabilizing effect or only to restrict it to an insignificant extent. Preferably, however, the function sequences of a wind energy generation unit or of the parameterization thereof which are expedient for this should be configured in an advantageous manner.

Embodiments of the invention are based on a method for operating a wind energy generation unit, in particular a wind turbine and/or a wind farm, for feeding electric power into an electrical supply grid, wherein an output power, in particular an active and/or reactive power is regulated and/or controlled by means of at least one power regulation module of a regulation and/or control device, said method comprising the following steps:
presetting a power regulation input value and determining a power regulation output value from the power regulation input value and outputting the power regulation output value, wherein
a time profile of the output power, in particular the reactive power, of the wind energy generation unit is detected over a first detection time period, and
a time profile of the line voltage of the electrical supply grid is detected over a second detection time period, wherein
a check is performed over the detection time period to ascertain whether the output power and the line voltage have an oscillation profile.

According to the invention, provision is furthermore made for
an oscillation with a period and with an amplitude to be assigned to the oscillation profile, and
it to be established that the oscillation continues over the detection time period and does not decrease in the process, and
a signal for signalling an oscillation buildup state to be output.

The first and second detection time periods are advantageously the same time period. The wind energy generation unit is advantageously a wind turbine, in particular an individual wind turbine, and/or a wind farm. An oscillation profile should generally be understood to mean any profile of an amplitude which is fluctuating or is the same with repetitions. Oscillation in a narrower sense is understood to mean an oscillation to which, at least temporarily, a fixed period or possibly changing period can be assigned, and possibly a varying amplitude.

Embodiments are based on the consideration that it is advantageous in principle to provide a first and/or second detection time period which, if not constantly in existence, is nevertheless in any case temporally limited, with the output power of the wind generation unit and the line voltage of the electrical supply grid being detected for the time window of said first and/or second detection time period. The detection of an output power of the wind generation unit and the line voltage of the electrical supply grid advantageously takes place already for reasons of power regulation and/or power control of the wind energy generation unit. Advantageously, the detection also takes place for reasons of grid stability monitoring. Examples of preferred power regulation, in particular power regulation which is dependent on line frequency, are explained in the description of the drawing.

Embodiments are based on the consideration that the occurrence of oscillation profiles in the output power of the wind energy generation is in any case an indication of there being a possibly undesirable instability of regulation and/or the occurrence of oscillation profiles in the line voltage is in any case an indication of there being a possibly undesired grid instability of the electrical supply grid. For operation of a wind energy generation unit, i.e., in particular of a wind turbine and/or a wind farm or another installation for energy generation from wind energy, a more reliable stipulation for the operation, for example, in respect of parameter setting of a regulator or an indication of what to regulate and/or control, is advantageously required in accordance with the findings of the invention in the event of the occurrence of an oscillation profile. In principle, oscillation profiles can also occur in this case without the abovementioned instabilities being present; for example, oscillation profiles can normally occur as a result of fluctuating wind conditions or certain power requirements or simply as parasitic or other oscillations which do not require regulation. Such oscillation profiles and other irrelevant oscillation profiles in this sense can be left unconsidered in the field of an operating method for a wind energy generation unit in accordance with the findings of the invention.

On the basis of these findings, provision is made according to the invention for an oscillation with a period and with an amplitude to be assigned to the oscillation profile and for it to be established, for this purpose, that the oscillation firstly continues over the detection time period and in the process secondly does not decrease. If the two abovementioned criteria are met, a signal is output which signals an oscillation buildup state. The first and second detection time periods or a test time period defined therein can be selected in an application-specific manner.

The abovementioned first criterion in accordance with which an oscillation with a period and with an amplitude can be assigned to the oscillation profile is based on the knowledge that there may even be non-periodic oscillation profiles which, in accordance with the concept of the invention, can be considered as inconsequential for a method for operating a wind energy generation unit or for control and regulation thereof. The invention is based on the finding that, to this extent, only eight oscillations, i.e. oscillations characterized by a period and an amplitude over the detection time period or in any case a relevant test time period, represent oscillation profiles which indicate an undesired instability. In this case, the invention can be guided by the consideration that ultimately an oscillation buildup behavior in the context of the operating method should be corrected. In principle, it is in this case nevertheless possible for fixed periodic profiles with a specific amplitude to be subject to a certain variance; i.e., the period can have a variation within a certain bandwidth, in particular when the variation follows a specific rule; this would be an indication of a system weakness which may cause an oscillation buildup behavior. To this extent, such oscillation profiles which are of a purely random nature should be eliminated without a periodic behavior being identifiable as said oscillation profiles progress over an arbitrarily short time period.

Embodiments are furthermore based on the finding that an amplitude of the oscillation can accordingly in principle be arbitrarily small, but if it is established that the oscillation continues over the detection time period and does not decrease in the process, in particular the amplitude of said oscillation does not decrease in the process, this is an indication of a system weakness which causes an oscillation buildup behavior.

In principle, findings, experience or other knowledge from the connection and operation of large-scale power plants to and on the electrical supply grid are not transferrable to wind turbines, including large-scale wind farms with a large number of wind turbines which are connected to the supply grid for feed-in. A competent person skilled in the art wishing to connect a power plant to a supply grid and operate such a power plant on such a supply grid is already a different type of person skilled in the art than one who wishes to connect a wind turbine to the supply grid and operate said wind turbine thereon. Wind turbines, and much of the following also applies to other decentralized generation units, are dependent on the wind and therefore need to take into consideration a fluctuating energy source; they generally do not feed into the supply grid with a synchronous generator which is coupled directly to the grid, but use a voltage-based inverter; they have a different order of magnitude than large-scale power plants, wherein their rated power is generally approximately three decimal powers below that of a large-scale power plant; they are generally subject to different political laws which often ensure a withdrawal of the power by the operators of electrical supply grids from said wind turbines; they are generally erected in decentralized fashion; they generally feed into a medium-voltage grid, whereas large-scale power plants generally feed into an ultra-high voltage grid.

These and other advantageous developments of the invention are set forth in the dependent claims and specifically specify advantageous possibilities for implementing the concept of the invention within the scope of the developments and with further advantages being indicated.

The abovementioned second criterion whereby the oscillation continues over the detection time period and does not decrease in the process can be checked in a particularly preferred manner in particular using further-reaching measures. Within the context of a preferred development, it is possible to specify further criteria for the amplitude profile. In particular, the identification of a lower threshold value amplitude being exceeded can already be sufficient for signalling an oscillation buildup state when the oscillation continues for a sufficiently long period of time, even if the amplitude should not decrease over time.

In particular, the identification of an upper threshold value amplitude being exceeded can on its own already be sufficient for signalling an oscillation buildup state, in particular independently of a duration of the oscillation and/or independently of a rise or fall behavior of the oscillation.

In principle, even in the case of the presence of an increasing amplitude, an oscillation buildup state can be identified independently of the magnitude or rise gradient of said amplitude or the duration of the oscillation. Even in the case of a constant amplitude, an oscillation buildup state can also be identified; possibly further conditions can be provided in the case of a constant amplitude, such as, for example, the stipulation whereby the constant amplitude should be present over a minimum time period.

Within the context of a particularly preferred development, a corresponding recognition algorithm provides for an increasing amplitude, a constant amplitude or a decreasing amplitude of an oscillation to be identified. A signal of an oscillation buildup state is only output in the case of an increasing or constant amplitude.

For example, already at this juncture reference is made to an increasing line voltage profile which has a line voltage amplitude above a rated voltage and tips to a spontaneous development of an oscillation after a certain time; this oscillation can firstly have a fixed period and secondly have an amplitude which rises with a high gradient and up to above an upper threshold value amplitude.

Within the context of a particularly preferred development, provision is made for at least one, preferably more, of the following parameters of an oscillation to be checked, wherein the parameter is selected from the group consisting of: amplitude of the oscillation, period of the oscillation, gradient profile of the amplitude of the oscillation, variance of the period, increase of the period, decrease of the period, gradient of a change in the period, continuation of an oscillation for longer than a limit time, frequency of the oscillation, frequency band of the oscillation, frequency amplitude of the oscillation.

Preferably, it is furthermore established whether the period has a period value within a period range over the detection time period. In other words, it is preferably established whether the period is within a period range and is identical to a lower period limit value and an upper period limit value or is between these values. Preferably, a lower period limit value of the period range can be between 0.05 s and 0.5 s. Preferably, an upper period limit value of the period range can be between 10 s and 30 s. The development has identified that only period lengths within the period range can be identified safely as those which indicate an instability. The development in this case uses empirical values from the regulation of wind energy generation units.

Preferably, it is furthermore established that the period continues substantially over the detection time period, in particular over a limit time value, and in particular maintains the period value preferably within the period range. In simplified terms, the intention is for it to be established whether the oscillation is an oscillation with a largely fixed period which is within a certain variance, but in any case has a period which, with a regularity, is constant, increases or decreases. Therefore, the possibility of there being a random or parasitic oscillation condition can in any case be ruled out comparatively easily. Preferably, a frequency spectrum of the time profile can be recorded in order to establish whether a certain frequency is within a preset frequency interval and/or is of a sufficient amplitude and/or has a width, within a specific bandwidth.

Furthermore, it has proven to be advantageous that an amplitude of the oscillation over the detection time period has an amplitude value above a threshold value amplitude. If an oscillation with an amplitude which is so great that is exceeds the threshold value amplitude is provided, advantageously it is concluded that there is an instability. In addition, it can be established whether the amplitude of the oscillation is above a lower threshold value amplitude for a minimum time period; in this case, even in the case of an amplitude value below the upper threshold value amplitude, it can be concluded that there is an oscillation buildup behavior. For similar analyses, only a single threshold amplitude value can also be provided which, when exceeded, indicates an oscillation buildup behavior.

In particular, it has proven to be advantageous that it is additionally established that the amplitude over the detection time period has an amplitude value which increases or possibly is constant. For example, it is possible to establish whether the gradient of an envelope of the oscillation is positive. In principle, it is particularly preferred to identify an oscillation buildup behavior when the gradient is above an amplitude gradient, preferably the oscillation increases with a comparatively high amplitude and/or quickly, i.e., with a high amplitude gradient.

It is preferred that a period interval and/or a threshold value amplitude, on the one hand, of a wind power, preferably output power, in particular active and/or reactive power, and on the other hand of a line voltage are set differently. In particular, it has proven to be advantageous that the parameters for identifying an oscillation buildup behavior of the wind power are set so as to be narrower than those for a line voltage. This stipulation is also based on experience with control and regulation systems for wind turbines, on the one hand, in comparison with a grid behavior of an electrical supply grid, on the other hand.

A regulation and control method in particular provides for parasitic and/or normal oscillation states, in particular oscillation states of the output power, preferably of the reactive power and/or active power and/or the line voltage, to be ruled out before a signal indicates an oscillation buildup state. For this purpose, it has proven to be advantageous to provide additionally precluding checks which are capable of identifying specifically known and regular states. This has the advantage that specific emergency situations do not result in signalling even in the case of the presence of all of the abovementioned criteria.

Within the context of a particularly preferred development, a regulation parameter of a regulation and/or control device and/or a supply grid device can be changed in the case of the presence of a signal indicating an oscillation buildup state. Preferably, the corresponding regulation parameter is restricted. Experience shows that situations in which regulation parameters are set too high and/or too narrowly at certain limits and/or with an excessively steep ramp, a control loop becomes unstable. Preferably, a gradient for matching a ramp can be reduced, for example, in order to make the ramp flatter and/or an output value of a control loop can be reduced on a percentage basis and/or a regulation parameter can be set to be lower and/or can be set to be further away from certain limits. Such and other measures can preferably be performed in order to restrict a regulation result or to restrict a grid and/or wind generation unit installation regulation device. For example, damping of a regulator and/or limitation of a regulator and/or of a regulation component can be provided; in particular the limitation of an I component of a regulator can be provided.

Preferably, an active and/or reactive power of the output power is checked. In particular, a check is performed on a setpoint value of the reactive power on the basis of the finding that the reactive power is suitable for assisting grid stability. In the case of the development, it is preferably ensured that in any case the reactive power of the output power is not already subject to irregularities as a result of excessively severe regulation. In any case, a grid stability can be assisted with reliable reactive power values in this way.

Within the context of a preferred development, the output power and the line voltage are monitored, in particular measured, constantly even beyond the detection time period. If appropriate, a constant test operation can also be set which in practice checks the output power and the line voltage in respect of an oscillation profile without any time limitation.

### BRIEF DESCRIPTION OF THE SEVERAL VIEWS OF THE DRAWINGS

Further details and advantages of the invention are disclosed in the exemplary embodiments in accordance with the drawing. Exemplary embodiments of the invention will now be described below with reference to the drawing. The drawing is not necessarily intended to represent the exemplary embodiments true to scale, but rather the drawing, where useful for explanatory purposes, is embodied in schematized and/or slightly distorted form. In respect of additions to the teachings which can be gleaned directly from the drawing, reference is made to the relevant prior art. In this case, it is necessary to consider that various modifications and amendments in respect of the form and the detail of an embodiment can be performed without departing from the general concept of the invention. The features of the invention disclosed in the description, the drawing and the claims can be essential to the development of the invention both individually and in any desired combination. In addition, all combinations of at least two of the features disclosed in the description, the drawing and/or the claims fall within the scope of the invention. The general concept of the invention is not restricted to the precise form or the detail of the preferred embodiment described and shown below or restricted to a subject matter which would be limited over the subject matter claimed in the claims. In the case of cited ranges of dimensions and ratings, values which are within the cited limits are also disclosed as limit values and can be used and claimed as desired. Further advantages, features and details of the invention are set forth in the description below relating to the preferred exemplary embodiments and with reference to the drawing, in which:

FIG. 1 shows a schematic of a wind turbine;

FIG. 2 shows a schematic of a wind farm;

FIG. 3 shows a schematic of a wind farm control facility in conjunction with a wind farm, for example from FIG. 2;

FIG. 4 shows a general design of a regulator with a regulation module, which can be used, parameterizable, particularly preferably as output power module (in particular active power regulation module or reactive power module), possibly after an internal preset value determination for an output power within the context of output power regulation;

FIG. 5 shows a first exemplary profile of a present line voltage of an electrical supply grid normalized to a rated voltage of a wind turbine (1000=100%), wherein the buildup of oscillation is identified and an oscillation buildup detection device or means outputs the value “1” for a positive identification;

FIG. 6 shows a similarly plotted second exemplary profile of a line voltage of the electrical supply grid normalized to a rated voltage of the wind turbine (1000=100%), wherein the buildup of oscillation is not identified and an oscillation buildup detection means outputs the value “0” for a negative identification correspondingly;

FIG. 7 shows a similarly plotted third exemplary profile of a line voltage of the electrical supply grid normalized to a rated voltage of the wind turbine (1000=100%), wherein the buildup of oscillation is only identified at a comparatively late point in time and an oscillation buildup detection means feeds back the value “1” for a positive identification;

FIG. 8 shows a similarly plotted fourth exemplary profile of a line voltage of the electrical supply grid normalized to a rated voltage of the wind turbine (1000=100%), wherein, in the case of a constant but comparatively long-lasting oscillation amplitude, again the buildup of oscillation is identified and an oscillation buildup detection means feeds back the value “1” for a positive identification;

FIG. 9 shows the basic design of a wind farm control and regulation device for a wind farm from FIG. 3 comprising a wind farm control facility organization unit and a wind farm control facility control and regulation module, and a wind farm control facility measurement and evaluation module connected thereto and a wind farm control facility oscillation buildup detection means;

FIG. 10 shows a method sequence for implementing a preferred oscillation buildup detection during operation of a wind turbine and/or a wind farm, wherein the method sequence can be implemented in particular with a wind farm control and regulation device from FIG. 9.

### DETAILED DESCRIPTION

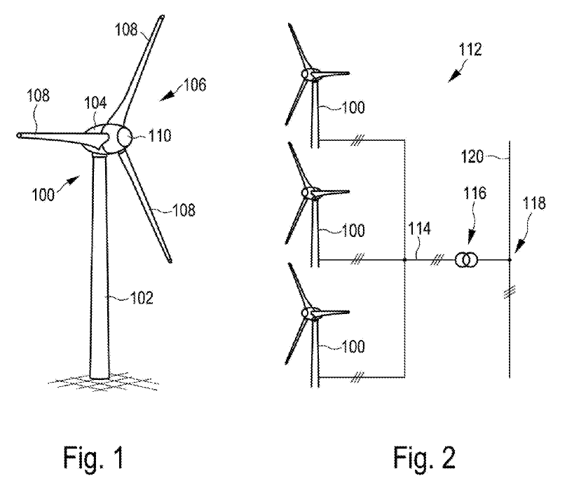

FIG. 1 shows a wind turbine 100 comprising a tower 102 and a nacelle 104. A rotor 106 comprising three rotor blades 108 and a spinner 110 is arranged on the nacelle 104. The rotor 106 is set in rotary motion by the wind during operation and thus drives a generator in the nacelle 104.

FIG. 2 shows a wind farm 112 comprising, by way of example, three wind turbines 100, which may be identical or different. The three wind turbines 100 are therefore representative of, in principle, any desired number of wind turbines in a wind farm 112. The wind turbines 100 provide their power, namely in particular the current generated, via an electrical wind farm grid 114. In this case, the respectively generated currents or powers of the individual wind turbines 100 are added up and usually a transformer 116 is provided, which steps up the voltage in the farm in order then to feed it into the supply grid 120 at the point of connection 118, which is generally also referred to as PoC. FIG. 2 is only a simplified illustration of a wind farm 112, which does not show a control facility, for example, although naturally a control facility is present. The wind farm grid 114 can also have a different configuration, for example, in which a transformer is also provided at the output of each wind turbine 100, for example, by way of mentioning only one other exemplary embodiment.

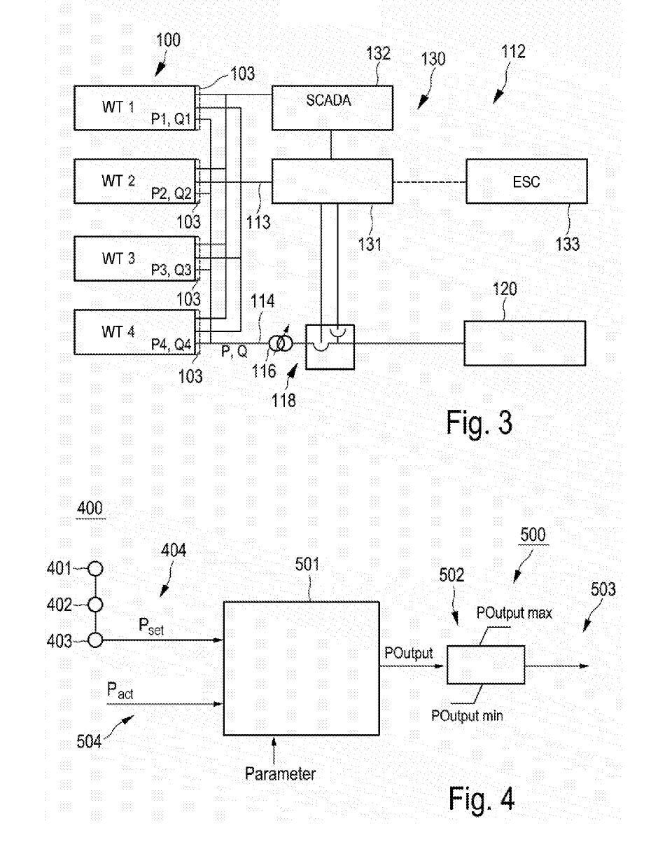

FIG. 3 shows an overview of a wind farm control system 130 in the case of a schematic design of the wind farm 112 comprising a number of wind turbines WT. The wind farm control facility 131 is a superordinate wind farm control and regulation unit. The reference point of this control and/or regulation is a reference point which is defined in project-specific fashion. Generally, this is identical to the point of connection 118 of the wind farm 112 at the medium-voltage or high-voltage grid, i.e., the supply grid 120. Generally, the point of connection 118 is a transformer substation or a main supply substation. Each one of the wind turbines WTi (in this case i=1 . . . 4), outputs active and reactive power Pi, Qi (in this case i=1 . . . 4), which are output into the wind farm grid 114 and are output as total active and reactive power P, Q via the transformer 116 to the point of connection 118 for output to the electrical supply grid.

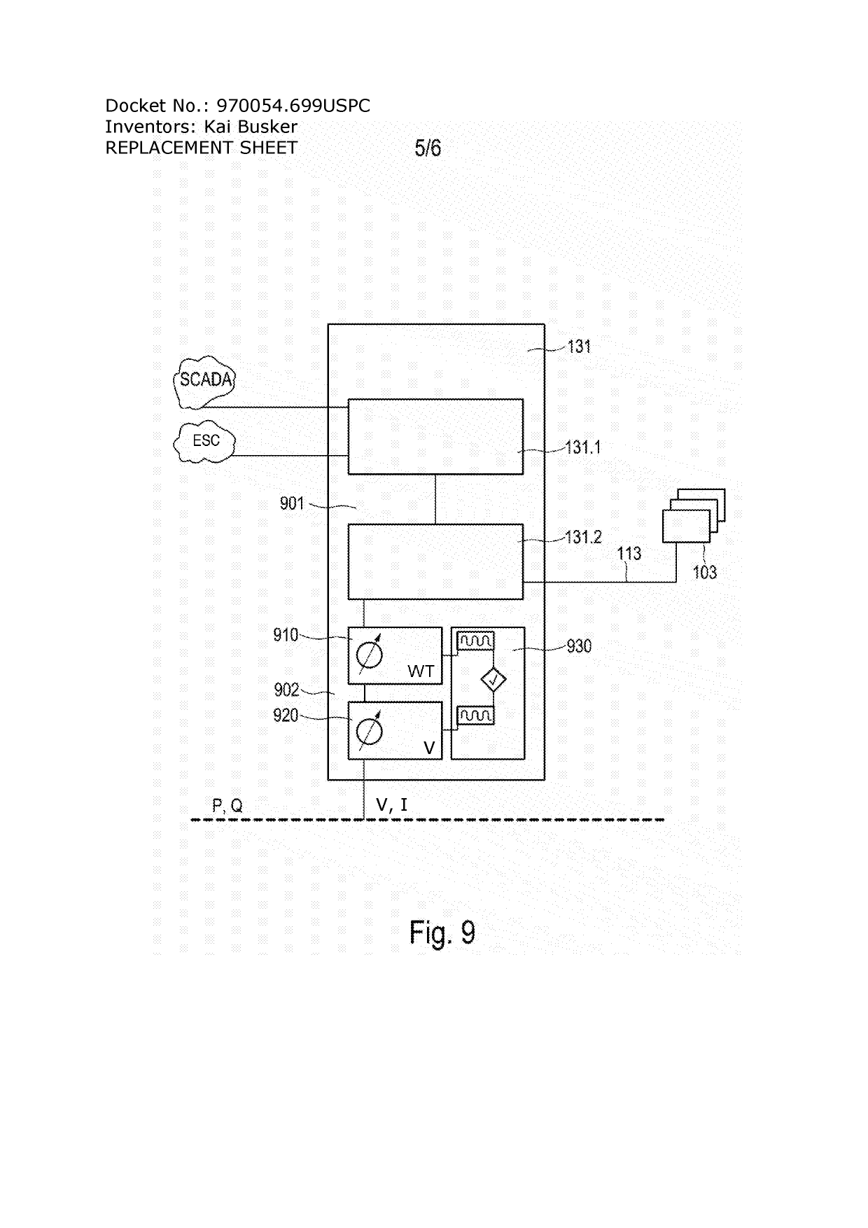

The wind farm control facility 131 has the possibility of voltage and current measurement at the point of connection 118, as is shown and explained in further detail with respect to FIG. 9.

In this case, a wind farm control system 130 is formed from a central unit (hardware and software) of a wind farm control facility 131 at the point of connection 118 and a SCADA wind farm control facility 132, which are also control-connected to a control room 133 of the grid operator. Data communication with the wind turbines WTi takes place via a dedicated data bus, the wind farm control bus. This is constructed in parallel with the SCADA bus. The wind farm control facility 131 cyclically requests information on the individual wind turbines WTi and needs to store this information for each of the wind turbines WTi (in this case i=1 . . . 4) in the memory.

Priorities between the wind farm control facility 131 and a SCADA wind farm control facility 132 can be established. The wind turbine 100 can feed at a point of connection 118 without any superordinate control or regulation. However, two superordinate wind farm control facilities and/or regulation facilities 131, 132 have proved successful. Therefore, there are various combinations for the feed. The settings for the different functions are performed on a control panel of the wind turbine 100 by means of an input apparatus, such as, for example, a touch panel or a PC. If none of the superordinate wind farm control facilities and/or regulation facilities is activated (for example wind farm control facility 131 or SCADA wind farm control facility 132), the presets established permanently in the control panel are used. If a wind farm control facility and/or regulation facility is intended to be used, this needs to be activated via the parameters on the control panel as setting. These settings result in four different combinations:
no farm regulation
wind farm control facility (and/or regulation facility) 131
SCADA wind farm control facility (and/or regulation facility) 132
wind farm control facility (and/or regulation facility) 131 and SCADA wind farm control facility (and/or regulation facility) 132.

The superordinate control facilities/regulators can have an influence on at least three different essential variables:
maximum active power of the installation (Pmax),
the reactive power, also including controls such as that from “Q to P”,
and the frequency-related available capacity (this in the case of activated frequency regulation).

A receiver unit, which is referred to here as wind turbine interface 103, is installed in each wind turbine 100. The wind turbine interface 103 is the interface of the wind farm control facility 131 in the wind turbine WTi. A panel of the wind turbine interface 103 acts as reception interface in each of the wind turbines WTi. It receives the setpoint values preset by the wind farm control facility 131, converts them, and passes on the information to the wind turbines WTi. This wind turbine interface 103 picks up the manipulated variables of the wind farm control facility 131 and passes them on to the wind turbine WTi. Furthermore, it takes on the monitoring of the data communication of the wind farm control bus 113 and organizes the default mode in the case of a disrupted data bus or in the event of failure of the wind farm control facility 131, possibly using a wind farm control facility organization unit 131.1 shown in more detail in FIG. 9.

The wind farm control facility 131 measures the voltage V and the current I at the point of connection 118, possibly using a grid measurement unit 920 shown in more detail in FIG. 9. A control panel with analogue inputs and microprocessors in the wind farm control facility, in particular control unit 131.2, analyses the grid and calculates the corresponding voltages, currents and powers.

The wind farm control facility 131 makes available a certain working range, which can be set by relevant hardware-related wind farm or hardware parameters. Some of the settings concern, for example, specifications relating to the rated voltage and/or the rated current on the low-voltage level, the medium-voltage level and/or the high-voltage level, the specification of a rated farm active power, the specification of a rated farm reactive power, the specification of the line frequency, the specification of the number of wind turbines in the farm and various settings for special functions, setpoint value presets and specifications in respect of data communication or control.

Furthermore, the following parameters can be established, such as: filter time constants, regulator reset options, grid fault undervoltage/overvoltage, preset value ramps; the limits which are permitted once as preset value or, for example, minimum and maximum powers for a wind turbine and limits of output values for a reactive power, active power, phase angle and limit values for maximum or minimum setpoint value presets relating to voltage, active and reactive power, phase angle and limit values for setpoint value presets on the external side can also be defined.

All standard preset settings of the wind farm control facility 131 can also be performed; there is a standard preset value for each preset value.

Regulators are constructed in two principal parts, wherein each part can have, for example, a preferred regulator design as shown in FIG. 4:
1. Regulation and/or control for the active power: active power regulator, power gradient regulator, power frequency regulator, power control facility, etc.
2. Regulation and/or control for the reactive power: voltage regulator, reactive power regulator, phase angle regulator, special regulator, reactive power control facility.

The wind farm control facility 131 is constructed in such a way that various regulator types can be selected, in particular for different basic types for the active power:
type 1: no active power regulator (only preset for a maximum and/or reserve power)
type 2: active power control facility (direct preset for a maximum and/or reserve power)
type 3: active power regulator without frequency dependence on the line frequency (without P(f) functionality)
type 4: active power regulator with frequency dependence on the line frequency (with P(f) functionality).

For example, FIG. 4 shows a preferred design of a power regulator, in particular active power regulator. In general, it is possible to distinguish between regulators according to a continuous and discontinuous behavior. The most well known continuous-action regulators include the “standard regulators” with P, PI, PD and PID behavior. Continuous regulators with an analogue or digital behavior can be used for linear controlled systems. A P regulator has a selected gain; owing to the lack of time behavior, the P regulator responds directly, but its use is limited because the gain needs to be reduced depending on the behavior of the controlled system. In addition, a system error of a step response after settling of the controlled variable remains present as “remaining system deviation” when there is no I element in the controlled system. A regulator which is known per se is the I regulator (integrating regulator, I component) for determining an I component whose step response in the I component results from time integration of the system deviation on the manipulated variable with the weighting by the integral-action time; a gain is inverse to the integral-action time. A constant system difference leads from an initial value of the output to the linear rise of the output up to its limit. The I regulator is a slow and precise regulator owing to its (theoretically) infinite gain. It does not leave any remaining system deviation, but only a weak gain or a large time constant can be set.

The so-called wind-up effect with a large signal behavior is known. When the manipulated variable is limited by the controlled system in the case of the I regulator, a so-called wind-up effect occurs. In this case, the integration of the regulator continues to function without the manipulated variable increasing. If the system deviation becomes smaller, an undesired delay of the manipulated variable and therefore the controlled variable occurs on the return. This can be countered by the limitation of the integration to the manipulated variable limits (anti-wind-up). A possible anti-wind-up measure is for the I component to be frozen at the last value when the input variable limitation is reached (for example by blocking of the I element). As in the case of each limitation effect within a dynamic system, the regulator then has a nonlinear behavior. The behavior of the control loop needs to be checked by numerical computation.

Within the context of a PI regulator (proportional-integral controller), there are components of the P element and of the I element with the time constant. It can be defined both from a parallel structure and from a series structure. In terms of signal technology, the PI regulator has the effect in comparison with the I regulator such that, after an input step, the effect of the regulator is moved forward by the integral action time. Owing to the I component, the steady-state accuracy is ensured, and the system deviation after settling of the controlled variable becomes zero. Thus, no system deviation results in the case of a constant setpoint value. Owing to the I element, the system deviation becomes zero in the steady state with a constant setpoint value. A PID regulator in combination with a D component can also be formed. The D element is a differentiator, which is normally only used in conjunction with regulators having a P and/or I behavior as regulator. It does not respond to the magnitude of the system deviation, but only to the rate of change thereof. A rise function causes a constant output signal at the D element. The magnitude of the output signal is dependent on the product of the rise constant and the derivative-action coefficient.

The basis of a regulation in FIG. 4 of a wind farm control facility 131, for example from FIG. 3, is the grid measurement, preferably with setting of filter time constants. The wind farm control facility 131 measures three grid voltages (to the neutral conductor and to ground potential) and three phase currents at the point of connection 118. A phasor is formed from this and is filtered corresponding to the grid quality. This filter can be set by a filter time constant and a series of parameters. The principal regulator structure can use so-called modules, of which one is shown in FIG. 4, as mentioned for the example of an active power regulator. A number of such or other modules which are interlinked in series can then form the function required for the respective project. So-called preset values 404 are preferably setpoint values for the regulators. The wind farm control facility 131 provides a value for all relevant setpoint values, such as, for example, a setpoint voltage value, a setpoint reactive power value, a setpoint phase angle (phi) value, a setpoint active power value, a setpoint available capacity value, in particular in a manner dependent on the line frequency (P(f) function).

Limits (min-max values) are established for each setpoint value in the wind farm control facility 131, in particular a wind farm control facility control unit 131.2 from FIG. 9. Such setpoint values can be preset directly at the wind farm control facility 131 or transmitted via an external interface. For the presetting 400 of preset values 404 by means of a setpoint value preset, first a few stages are run through until the value is available as input variable at the actual regulation module 501 of the regulator 500. A preliminary setpoint value is generated at a setpoint value generation step 401, either directly at the wind farm control facility 131 or via an external setpoint value interface. This preliminary setpoint value runs through limitation 402 with a maximum value and a minimum value (in this case with a Pmax value and a Pmin value for an active power). These values are stored as parameters in the wind farm control facility 131. The resultant setpoint value runs through a so-called setpoint value ramp 403. The setpoint value ramp is intended to prevent sudden changes in the setpoint value. Parameters are settings or values which are permanently preset in the wind farm control facility 131 and which can be set only using the control facility itself. They are then stored in the control facility. They act as operational parameters and therefore define the behavior of the wind farm control facility 131 and therefore of the regulator.

Then, the wind turbines 100 receive the same control signal (POutput) from the regulation module 501 in accordance with the preset of the setpoint output power 503. As a result, first those installations which also produce more power at that time are limited first in the case of a power reduction in 502. The principal regulator design 500 is in principle the same in comparison with that in FIG. 4 even when using a regulation module which has been modified or supplemented in function-specific fashion. The input variable (in this case Pset (either input directly at the wind farm control facility 131 or preset by the external interface) can be standardized to the rated farm power (Pnominal), as part of a preset value determination 400. Then, the set limits for the preset value are checked in the limitation stage 402 (these are stored as parameters in the wind farm control facility 131, Pmin, Pmax). This setpoint value is not applied immediately in the case of a setpoint value change, but changes with a corresponding setpoint value ramp 403. The ramp gradient is in turn a parameter in the wind farm control facility 131. The resultant value then acts, as explained, as preset value 404 for the actual regulator 500 with regulation module 501, in this case for the example of active power. The back-measured power (Pact) at the point of connection 118 acts as actual variable for the regulation module 501. This variable can be filtered depending on the parameterization. The actual power 504 can also be standardized to the rated wind farm power (Pnominal). The regulation module 501 of the regulator 500 for active power as shown in FIG. 4 (or for example exactly the same for reactive power) is an autonomous module which can be called up by various regulators or can be used as a simplified module in the case of other regulators.

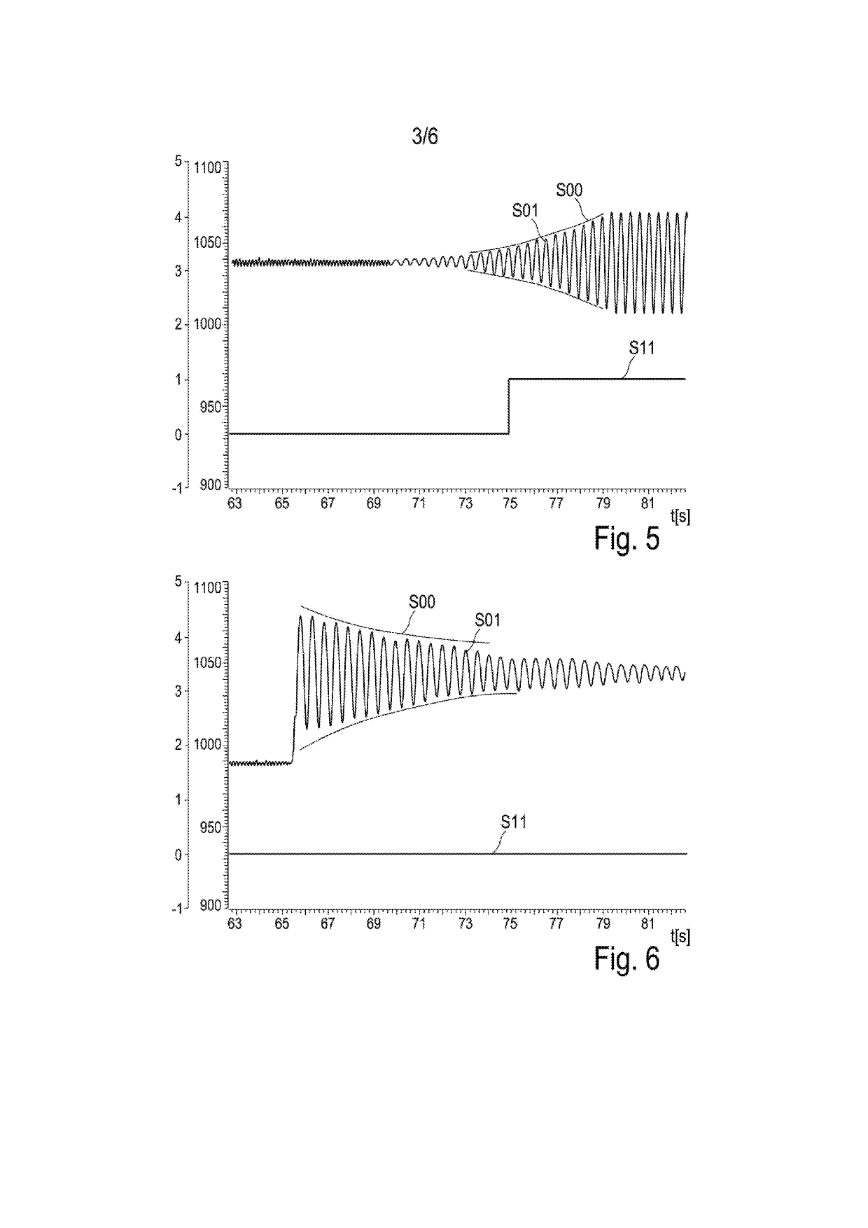

Such regulator accessories as in FIG. 4 and other regulator accessories can become unstable not only in a manner inherent to the abovementioned regulator-based wind-up but also in a plant-specific manner. Possibilities to be expected are shown in FIG. 5 to FIG. 8. In order to identify an oscillation buildup behavior of a wind turbine and/or a wind farm, firstly a line voltage is monitored. In order to clarify the function and in order to evaluate errors of an oscillation, examples are shown in FIG. 5 to FIG. 8. In response to this, an oscillation buildup detection means can output a corresponding signal indicating a positive identification “(1)” or negative identification “(0)”. To this extent, in

FIG. 5 to FIG. 8, the signal “S01”, the present line voltage, is normalized to the rated voltage*1000 (=100.0%); the signal “S00” denotes the corresponding envelope which connects the amplitude values of the oscillation signal “S01”. The signal “S11” is the result of the oscillation analysis of the oscillation buildup detection means (0=OK, 1=oscillation identified).

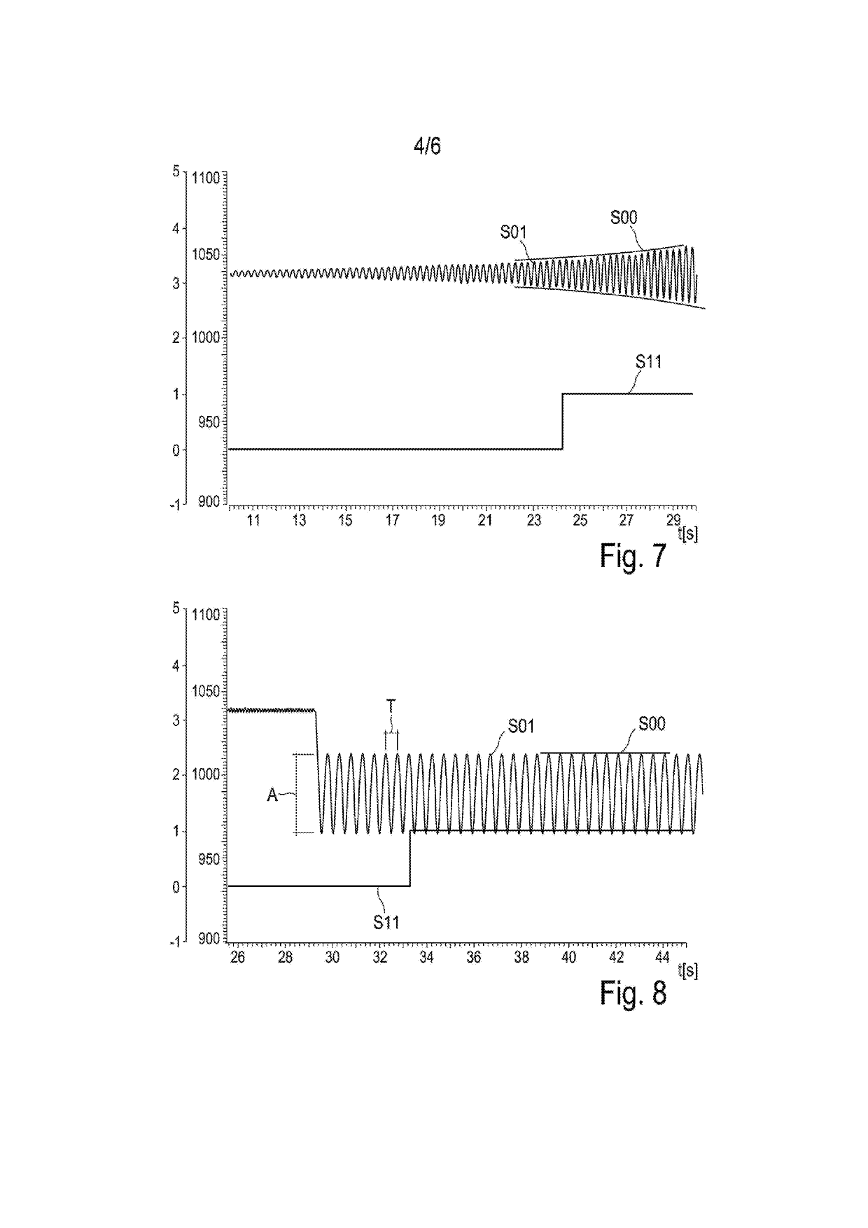

In FIG. 5, the line voltage is 1.040 (i.e., 4% overvoltage) before the oscillation begins. In the oscillation buildup detection, the value “(1)” is output, which means that an oscillation has been identified, which, in a comparatively reliable manner, represents an oscillation buildup behavior. An oscillation buildup state is identified, in the case of FIG. 5 and also in the case of FIG. 7, when an oscillation with a steady period is identified for which a rise in amplitude is established.

This is initially independent of the absolute magnitude of the amplitude; at the latest at a comparatively late point in time in FIG. 7, the amplitude exceeds a lower threshold value amplitude, with the result that in this case, too, an oscillation buildup state is identified and a corresponding signal is output. FIG. 7 shows a very slow buildup of oscillation of the line voltage with a low frequency. In the oscillation buildup detection, the value “(1)” is output; i.e., an oscillation is identified which, in a comparatively reliable manner, represents an oscillation buildup behavior.

FIG. 8 shows a constant oscillation after a change in setpoint value. In the oscillation buildup detection, the value “(1)” is output, which means that an oscillation has been identified which, in a comparatively reliable manner, represents an oscillation buildup behavior. Even in the case of the example in FIG. 8, an oscillation buildup state is identified after a change in setpoint value. In the case of a constant period and amplitude present here, it can be concluded that there is an undesired state, already owing to the long-lasting profile of the oscillation. In the present case, in addition the amplitude of the oscillation above a lower threshold value amplitude is provided, with the result that an oscillation buildup state can safely be signaled.

FIG. 6 secondly shows the behavior in the case of a severely parameterized regulator after a change in setpoint value (from 0.95 to 1.04). In the oscillation buildup detection, the value “(0)” is output, which means that an oscillation has been identified which, in a comparatively reliable manner, does not represent an oscillation buildup behavior; put simply no oscillation is identified. In the case of FIG. 6, even in the case of a lower threshold value amplitude being exceeded, an oscillation buildup state cannot be identified since a gradient of the amplitude profile is negative.

The concept explained by way of example here therefore includes an evaluation in which it is identified whether the oscillation is increasing, remains constant or decays. For example, a severely parameterized regulator tends towards an overshoot in the case of a change in setpoint value. The oscillation in FIG. 6 is decaying and must therefore not result in a state which would be signaled as an oscillation buildup state; instead, such a state as in FIG. 6 is insignificant in comparison with a state in FIG. 5, FIG. 7 and FIG. 8.

FIG. 9 shows a wind farm control facility 131 illustrated in FIG. 3 in detail, namely with a wind farm control facility organization unit 131.1 (“Management”) and a wind farm control facility control unit (and/or regulation unit) 131.2. The wind farm control facility organization unit 131.1 organizes different control units such as, for example, a SCADA control facility or a control facility 133 of the energy supply companies (ESC) which monitor in particular the grid states; to this extent the wind farm control facility organization unit 131.1 is responsible for prioritizing or coordinating different control presets. The actual wind farm control facility control unit (and/or regulation unit) 131.2 receives signals from a wind farm control facility interface 103 of the wind turbine WTi (in this case i=1 . . . 4) or outputs signals to the wind farm control facility interfaces 103 via a wind farm control bus 113. Furthermore, the wind farm control facility 131 at present has a number of regulation modules, as is shown in principle in FIG. 4; namely for implementing suitable control and regulation presets as are described inter alia with reference to FIG. 4. These can have the mentioned susceptibilities or an inclination towards oscillation buildup processes in the course of only conditionally provided matching of a regulator to a controlled system (wind turbine). Such a control and regulation module 901 as shown in FIG. 9 is used for presetting a power regulator input value and determining a power regulation output value from the power regulation input value and outputting the power regulation output value.

In addition, the wind farm control facility 131 has a measurement and evaluation module, with there being a plurality of units of the measurement and evaluation module 902. The measurement and evaluation module 902 accordingly has a plant measurement unit 910 and a grid measurement unit 920, which are both connected in terms of signalling to an oscillation buildup detection unit 930. The plant measurement unit 910 is designed to detect actual values and setpoint values of the control and regulation module 901 and to supply these actual and setpoint values to the oscillation buildup detection unit 930. The grid measurement unit 920 is designed to measure the line voltage U and/or a line current I at the point of connection 118 and to supply corresponding results to the oscillation buildup detection unit 930.

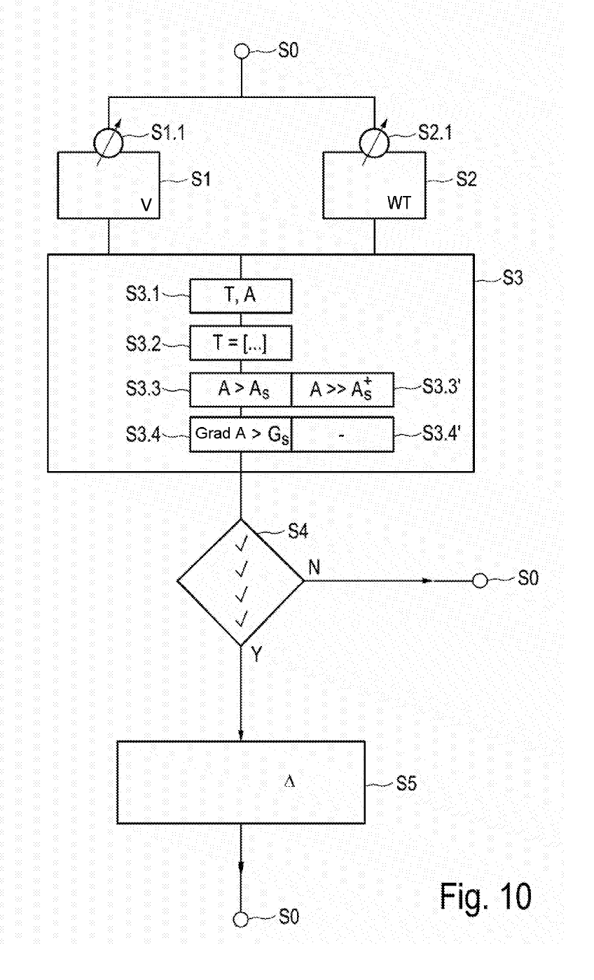

FIG. 10 shows, schematically, a method by means of which oscillation buildup states of a wind turbine WT (for example as shown in FIG. 1) and/or a wind farm (for example as shown in FIG. 2) can be identified comparatively reliably as real oscillations as a safety measure, in particular those which are caused by the mode of operation of the wind turbine 100 and/or the wind farm 112 whilst coupled to the electrical supply grid 120. The aspect of an oscillation buildup detection has only been identified as being particularly relevant by the present concept for an oscillation profile which has proven to be a real buildup of oscillation in the case of a wind turbine and/or a wind farm coupled to the electrical supply grid. This is because there is a number of oscillation phenomena of a voltage and/or a current of the supply grid 120 itself which can possibly not be changed by a change in or restriction of parameters of the wind turbine 100 and/or the wind farm 112. To this extent, within the context of the present embodiment of a method for oscillation buildup detection, it has proven to be advantageous that such parasitic or normal or desired oscillation states remain unconsidered to an insignificant extent.

A particularly notable example case for the application of the method described below for oscillation buildup detection is a situation in which a wind farm is not yet complete or, in the complete state, is provided with a wind farm control facility 131 (for example as shown in FIG. 3) whose actuating behavior is intended to be tested. For this purpose, the parameters of the wind farm control facility 131 or control facility of a wind turbine can be temporarily increased or set more precisely. This results in an improved actuating behavior of the respective wind farm control facility 131, with the result that, as part of a test, the capability of the wind farm control facility 131 to respond to circumstances on the electrical supply grid 120 can be tested in a particularly reliable manner. During regular operation, parameter settings of the wind farm control facility 131 which are set too precisely have proven to be less suitable, however, and regulation phenomena with an oscillation behavior may result, which are detected and eliminated as part of the present oscillation buildup detection.

### 1. Oscillation of a Line Voltage U of the Electrical Supply Grid 120

The line voltage U (in particular a phase-to-phase line voltage, in accordance with the space vector method) is monitored constantly for an oscillatory behavior by an oscillation buildup detection unit 930 from FIG. 9. The intention thereby is to identify when a regulation algorithm (voltage regulator, reactive power regulator) becomes unstable. Under certain circumstances, this could arise with suggestion of the possibilities in FIG. 5 to FIG. 8 when regulation parameters are set too severely or even when grid states change or when setpoint value presets are changed.

The algorithm for identifying an oscillation monitors the signal of a line voltage, as shown in FIG. 10, and attempts to identify the buildup of oscillation. There are certain boundary conditions which should be present preferably in accordance with the concept described here:
the oscillation of a line voltage in the supply grid 120 should be periodic;
oscillations of the line voltage in the supply grid 120 should preferably be identified between 100 ms and 20 s;
the amplitude of the oscillations of the line voltage in the supply grid 120 should exceed a certain value;
the oscillations of the line voltage in the supply grid 120 should increase; decaying oscillations are ignored.

### 2. Oscillation of a Reactive Power (Q Setpoint) in a Wind Turbine (WT):

The reactive power setpoint value of a wind turbine WT (setpoint value for the WT, output variable from the wind farm control facility 131) is monitored constantly for oscillatory behavior. As a result, it should be identified when a regulation algorithm (voltage regulator, reactive power regulator) becomes unstable. Under certain circumstances, this could arise with indication of the possibilities in FIG. 5 to FIG. 8 when regulation parameters are set too severely or else when grid states change or when setpoint value presets are changed.

In principle, a similar algorithm can be used as is described in the case of oscillation of a line voltage U. In the present case, however, the evaluation criteria have been matched differently, i.e., there are likewise certain boundary conditions in this case in accordance with FIG. 10:
the oscillation of the reactive power (Q setpoint) should be periodic;
only oscillations of the reactive power between 100 ms and 20 s are preferably identified;
the amplitude of the oscillation of the reactive power should exceed a certain value;
the oscillation of the reactive power should increase;
decaying oscillations are ignored;
the control should be greater than in the case of monitoring of the line voltage U. The reason for this is that the reactive power regulator is intended to compensate for any other oscillations which may occur.

According to FIG. 10, in a starting method step S0, the oscillation buildup detection can be activated; this has proven to be expedient in particular in the case of a situation as described above. In particular, it is thus possible to avoid a situation in which, in the case of activation during transition to a regular operating mode, a set of parameters which is set too severely of the wind farm control facility 131 is restricted or is transferred to a regulator set of parameters.

For this purpose, in a further first step S1, a time profile of the line voltage U of the electrical supply grid 120 is detected over a first detection time period. This takes place in this case within the context of a measurement S1.1 at the point of connection 118 to the electrical supply grid 120. This detection measure has proven to be particularly expedient for the case where a grid stability tends to be weak; in this case, an established oscillation over the detection time period would already represent a strong indication of an oscillation buildup state.

In a further second step S2, the active power Q of the wind turbine WT is detected as time profile over a second detection time period; preferably the first and second detection time periods correspond to one another and the active power Q and the line voltage U are detected simultaneously. In particular, it has been demonstrated that the detection of a setpoint value of the reactive power Qset in a step S2.1 at a wind farm control facility interface 103 with respect to the wind turbine WT, 100 is advantageous. The reason for such a measure could be that establishing an oscillation has proven to be significant for an oscillation buildup state in particular when the grid stability is comparatively high. Then, the oscillating reactive power points towards a regulator oscillation, whose oscillation buildup behavior should be eliminated.

The combinations of the further steps S1 and S2 incorporates both weak grid stability situations and strong grid stability situations. In other words, the first step S1 is directed to the monitoring of oscillations at the point of connection 118 to the supply grid 120, while the second step S2 is directed to the monitoring of oscillations at the wind turbine WT itself. The combination of the two steps S1, S2 monitors oscillations as can arise in the case of a coupled wind turbine 100 or a coupled wind farm 112 to an electrical supply grid 120 and which can contribute to undesired oscillation buildup states. Both parameters of a line voltage V and a reactive power Qset can be measured comparatively easily in steps S1.1 and S2.1 or are provided as measurement parameters already within the scope of normal regulation by means of a wind farm control facility 131 for a wind farm 112. They are therefore already available in a comparatively simple manner and can be used for the further process.

In a third further step S3, it is established whether the output power and the line voltage V have an oscillation profile, which is present as an oscillation with a period T and with an amplitude A and which can be characterized as oscillation buildup state over the detection time period, i.e., which in particular does not decrease.

For this purpose, in a first test step S3.1, it is established whether a period T and an amplitude A can be assigned to the oscillation over the detection time period. In other words, it is established whether it is a relevant oscillation at all and not merely a steady-state oscillation which cannot be categorized as a relevant oscillation. For this purpose, if appropriate, it is possible to check whether an established period T can be assigned to a high frequency with a sufficiently low bandwidth and it is possible in addition to check whether the established period T fluctuates no more than a preset variance in the detection time period. Preferably, it is established that the period T can be assigned to always the same frequency, i.e., is constant over the detection time period.

In a second test step S3.2, a test is then performed to ascertain whether the established period T, if relevant, is within a period time interval I=[ . . . ] which in this case only considers oscillations with periods T between 100 ms and 20 s as relevant in any case. These limit values for the period interval I can result from experience relating to the generally set wind farm control and/or regulation system 130 and wind farm control properties for a wind turbine 100 or for a wind farm 112. In addition, alternate supply grid states occurring as a result with other oscillation states are ruled out.

In a third test step S3.3, it is established whether the measured amplitude A is above a threshold value amplitude Aₛ (i.e., A>Aₛ). If this is the case, in a fourth test step S3.4, a test is performed to ascertain whether the amplitude values of the amplitude A increase with time over the detection time period; i.e., a test is performed to ascertain whether the gradient Grad A is above a limit gradient Gₛ. The method described here therefore does not take into consideration oscillations whose amplitude value of the amplitude A is sufficiently low or else whose amplitude value decreases at a sufficient rate.

In one variant, in a third test step S3.3′, a test can also be performed to ascertain whether the measured amplitude is above an upper threshold value amplitude (A>>Aₛ⁺); if this is the case, irrespective of whether the amplitude A is increasing or falling in step S3.4′, it is possible to identify that an oscillation buildup state is present. This stipulation is based on the experience that, in the case of sufficiently high amplitudes A>>Aₛ⁺, the system reaches its limits and then, irrespective of whether there is oscillation buildup, oscillation decay or constant oscillation, the regulating parameter of the wind farm control facility 131 can be restricted.

If, in step S4, all results are positive for the abovementioned test steps S3.1, S3.2, S3.3, S3.4 or S3.1, S3.2, S3.3′, S3.4′, i.e., all test queries are answered by “YES”, a set of parameters of the wind farm control facility 131 needs to be restricted in terms of its values by suitable restriction values A in a fifth step S5, following the “Y branch” of the method, i.e., generally corresponding actuating parameters, ramps or similar preset values of the regulators then need to be reduced, restricted or damped. The method can then in turn be resumed with step S0 and can then run in a loop, if appropriate.

Otherwise, if only one of the test steps S3.1, S3.2, S3.3, S3.4 or S3.1, S3.2, S3.3′, S3.4′ can also be responded by “NO”, provision is made here for a change to parameters for the regulators 500 of the wind farm control facility 131 to be omitted. The basic concept of this development consists in that a large proportion of oscillations which do not correspond to all four of the abovementioned test criteria S3.1 to S3.4/S3.4′ are either decreasing (i.e., disappearing on their own) or are too small (and therefore inconsequential). In this case too, the test method for detecting an oscillation buildup behavior can then be run through further with step S0 as a loop.

As a result, on consideration of the two parameters (namely the line voltage V and the output power, in particular reactive power (Q set)) with the mentioned test queries, a real oscillation buildup behavior is identified as oscillation and a distinction is drawn between random, normal or parasitic oscillation states. In particular, other oscillation phenomena which do not have an upswing are identified or are ruled out from a regulation correction by a parameter change Δ in step S5.

1. A method for operating at least one of a wind turbine and a wind farm for feeding electric power into an electrical supply grid, said method comprising the following steps:
regulating an output power by at least one power regulation module of at least one of a regulation device and control device, wherein said regulating includes:
presetting a power regulation input value;
determining a power regulation output value from the power regulation input value; and
outputting a power regulation output value, wherein:
a time profile of the output power of the wind turbine is detected over a detection time period, and
a time profile of a line voltage of the electrical supply grid is detected over the detection time period,
performing a check over the detection time period to ascertain whether the output power and the line voltage have an oscillation profile,
assigning an oscillation with a period and with an amplitude to the oscillation profile, and
wherein the oscillation continues over the detection time period and does not decrease in the process, and
outputting a signal for signalling an oscillation buildup state.

2. The method according to claim 1, wherein the period over the detection time period has a period value within a period range.

3. The method according to claim 1, wherein a lower period limit value of the period range is between 0.05 s and 0.5 s.

4. The method according to claim 1, wherein an upper period limit value of the period range is between 10 s and 30 s.

5. The method according to claim 1, wherein the period over the detection time period has a largely continuous period value.

6. The method according to claim 1, wherein the amplitude over the detection time period has an amplitude value above a threshold value amplitude.

7. The method according to claim 1, wherein the amplitude over the detection time period has an amplitude value which increases.

8. The method according to claim 1, wherein a period interval for a reactive power and a period interval for a line voltage are different and/or a threshold value amplitude for a reactive power and a threshold value amplitude for a line voltage are different.

9. The method according to claim 1, wherein at least one of parasitic and normal reactive power oscillation states are ruled out before the signal indicates the oscillation buildup state.

10. The method according to claim 1, wherein the signal indicating the oscillation buildup state is changed for eliminating a regulation parameter which has been set excessively severely, a regulation parameter of a regulation and/or control device and/or of a supply grid device.

11. The method according to claim 1, wherein a reactive power of the output power is monitored.

12. The method according to claim 1, wherein beyond the detection time period, the output power and the line voltage are monitored.

13. A regulation and/or control device for operating at least one of a wind turbine and a wind farm, wherein the regulation and/or control device is configured to implement a method according to, claim 1, the regulation and/or control device comprises:
a regulation module for presetting a power regulation input value and determining a power regulation output value from the power regulation input value and outputting the power regulation output value,
an installation measurement module for detecting a time profile of the output power of the wind energy generation over a detection time period, and
a grid measurement unit for detecting a time profile of the line voltage of the electrical supply grid over a detection time period, and
an evaluation module configured to check whether the output power and the line voltage have an oscillation profile over the detection time period, wherein:
the evaluation module is further designed to assign an oscillation with a period and with an amplitude to the oscillation profile,
the evaluation module further has an oscillation buildup detection unit configured to determine that the oscillation is continuing over the detection time period and does not decrease, and
a signal transmitter for outputting a signal indicating an oscillation buildup state.

14. The regulation and/or control device according to claim 13, wherein the evaluation module comprising the oscillation buildup detection means is part of at least one of a wind turbine control facility and wind farm control facility, wherein the installation measurement module and the grid measurement module are a device at the point of connection.

15. A wind turbine comprising a regulation and/or control device according to claim 13.

16. A wind farm comprising at least one wind turbine and a regulation and/or control device according to claim 13.

17. The method according to claim 8, wherein at least one of the period interval and the threshold value amplitude of the reactive power is less than the period interval and the threshold value amplitude of the line voltage, respectively.

18. The method according to claim 10, wherein the signal indicating the oscillation buildup state is restricted.

19. The method according to claim 11, wherein a setpoint value of the reactive power or an actual value of the reactive power is monitored.

20. The method according to claim 12, wherein beyond the detection time period, the output power and the line voltage are measured, wherein a check is performed beyond the detection time period to ascertain whether the output power and the line voltage have an oscillation profile.
